(19) United States
(12) Patent Application Publication
(10) Pub. No.: US 2023/0373751 A1
(43) Pub. Date: Nov. 23, 2023

(54) APPLICATION SERVER ASSOCIATED WITH AN ELEVATOR COMMUNICATION SYSTEM, AN ELEVATOR SYSTEM AND A METHOD

(71) Applicant: KONE Corporation, Helsinki (FI)

(72) Inventor: Ari KATTAINEN, HELSINKI (FI)

(73) Assignee: KONE Corporation, Helsinki (FI)

(21) Appl. No.: 18/228,355

(22) Filed: Jul. 31, 2023

Related U.S. Application Data
(63) Continuation of application No. PCT/EP2021/052327, filed on Feb. 1, 2021.

(51) Int. Cl. B66B 1/34; B66B 5/02; B66B 5/00; B66B 3/00

(52) U.S. Cl. CPC B66B 1/3461; B66B 5/024; B66B 5/025; B66B 1/3453; B66B 5/0031; B66B 3/008

(57) ABSTRACT

An application server is configured to receive first information associated with an elevator communication network configured to carry data associated with a plurality of elevator system nodes communicatively connected to the elevator communication network; and provide an application interface towards at least one client, the application interface enabling provision of at least part of the first information associated with the elevator communication network to the at least one client.

### TECHNICAL FIELD

The present application relates to the field of elevator communication systems, and more specifically to an application server communicatively connected to the elevator communication system, and to an elevator system and to a method in the elevator system.

### BACKGROUND

In modern elevator system, elevators can be controlled efficiently to transport passenger between floors in a building. However, sometimes it may happen, for example, in a fire emergency situation elevators may be used by the rescue personnel to reach various floors of a building. Further, the fire situation experienced in various landing floors and by elevators may vary significantly, and the rescue personnel may not always have up to date information about the situation in different parts of a building. Further, there may be also other occasions when information provided by the elevator system would be useful.

Thus, it would be beneficial to have a solution that would alleviate at least one of these drawbacks.

### SUMMARY

According to a first aspect, there is provided an application server. The application server is configured to receive first information associated with an elevator communication network configured to carry data associated with a plurality of elevator system nodes communicatively connected to the elevator communication network; and provide an application interface towards at least one client, the application interface enabling provision of at least part of the first information associated with the elevator communication network to the at least one client.

In an implementation form of the first aspect, the application server is configured to obtain a triggering event from the elevator communication network; and open the application interface towards the at least one client in response to the triggering event.

In an implementation form of the first aspect, the triggering event comprises a fire alarm or a burglar alarm.

In an implementation form of the first aspect, the application server is configured to determine, based on the first information, that at least one parameter in the first information exceeds a predetermined threshold; and open the application interface towards the at least one client in response to the determination.

In an implementation form of the first aspect, the application server is configured to determine, based on the first information, that at least one parameter in the first information exceeds a predetermined threshold; and issue at least one alert via the application interface to the at least one client in response to the determination.

In an implementation form of the first aspect, the application server is configured to receive via the application interface information indicating a selection of a landing floor; and wherein the at least part of the first information associated with the elevator communication network comprises information associated with the selected landing floor.

In an implementation form of the first aspect, the application server is configured to receive via the application interface information indicating a selection of an elevator; and wherein the at least part of the first information associated with the elevator communication network comprises information associated with the selected elevator.

In an implementation form of the first aspect, the application server is configured to receive second information via the application interface from the at least one client; and transmit the second information to the elevator communication network to enable a two-way connection between the elevator communication network and the at least one client.

In an implementation form of the first aspect, the second information comprises at least one of image data and voice data.

In an implementation form of the first aspect, the first information comprises at least one of image data, voice data, status data and sensor data.

In an implementation form of the first aspect, the at least one of image data, voice data, status data and sensor data comprises at least one of: image and/or voice data associated with at least one landing floor; image and/or voice data associated with at least one elevator car; image and/or voice data associated with at least one elevator shaft; status data associated with at least one elevator car; status data associated with an operation mode of an elevator; data associated with at least one elevator system failure; data associated with at least one component failure; data associated with at least one rescue need associated with the elevator system; sensor data associated with carbon dioxide; sensor data associated with carbon monoxide; sensor data associated with temperature; and sensor data associated with air moisture.

In an implementation form of the first aspect, the elevator communication network comprises at least one point-to-point ethernet network.

In an implementation form of the first aspect, the elevator communication network comprises at least one multi-drop ethernet segment.

According to a second aspect, there is provided an elevator system comprising an elevator communication network configured to carry data associated with a plurality of elevator system nodes communicatively connected to the elevator communication network; and the application server of the first aspect.

According to a third aspect, there is provided a method comprising: receiving, by an application server, first information associated with an elevator communication network configured to carry data associated with a plurality of elevator system nodes communicatively connected to the elevator communication network; and providing, by the application server, an application interface towards at least one client, the application interface enabling provision of at least part of the first information associated with the elevator communication network to the at least one client.

In an implementation form of the third aspect, the method further comprises obtaining a triggering event from the elevator communication network; and opening the application interface towards the at least one client in response to the triggering event.

In an implementation form of the third aspect, the triggering event comprises a fire alarm or a burglar alarm.

In an implementation form of the third aspect, the method further comprises determining, based on the first information, that at least one parameter in the first information exceeds a predetermined threshold; and opening the application interface towards the at least one client in response to the determination.

In an implementation form of the third aspect, the method further comprises determining, based on the first information, that at least one parameter in the first information exceeds a predetermined threshold; and issuing at least one alert via the application interface to the at least one client in response to the determination.

In an implementation form of the third aspect, the method further comprises receiving via the application interface information indicating a selection of a landing floor; and wherein the at least part of the first information associated with the elevator communication network comprises information associated with the selected landing floor.

In an implementation form of the third aspect, the method further comprises receiving via the application interface information indicating a selection of an elevator; and wherein the at least part of the first information associated with the elevator communication network comprises information associated with the selected elevator.

In an implementation form of the third aspect, the method further comprises receiving second information via the application interface from the at least one client; and transmitting the second information to the elevator communication network to enable a two-way connection between the elevator communication network and the at least one client.

In an implementation form of the third aspect, the second information comprises at least one of image data and voice data.

In an implementation form of the third aspect, the first information comprises at least one of image data, voice data, status data and sensor data.

In an implementation form of the third aspect, the at least one of image data, voice data, status data and sensor data comprises at least one of: image and/or voice data associated with at least one landing floor; image and/or voice data associated with at least one elevator car; image and/or voice data associated with at least one elevator shaft; status data associated with at least one elevator car; status data associated with an operation mode of an elevator; data associated with at least one elevator system failure; data associated with at least one elevator system component failure; data associated with at least one rescue need associated with the elevator system; sensor data associated with carbon dioxide; sensor data associated with carbon monoxide; sensor data associated with temperature; and sensor data associated with air moisture.

In an implementation form of the third aspect, the elevator communication network comprises at least one point-to-point ethernet network.

In an implementation form of the third aspect, the elevator communication network comprises at least one multi-drop ethernet segment.

According to a fourth aspect, there is provided a computer program comprising program code, which when executed by at least one processing unit, causes the at least one processor to perform the method of the third aspect.

According to a fifth aspect, there is provided a computer readable medium comprising program code, which when executed by at least one processor, causes the at least one processor to perform the method of the third aspect.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1A illustrates an elevator communication system according to an example embodiment.

FIG. 1B illustrates an elevator communication system according to another example embodiment.

FIG. 1C illustrates an elevator communication system according to another example embodiment.

FIG. 1D illustrates an elevator communication system according to another example embodiment.

FIG. 2 illustrates an apparatus configured to provide an application server according to an embodiment.

FIG. 3 illustrates a method according to an example embodiment.

FIG. 4A illustrates a simplified graphical user interface view provided by a client according to an example embodiment.

FIG. 4B illustrates a simplified graphical user interface view provided by a client according to an example embodiment.

FIG. 4C illustrates a simplified graphical user interface view provided by a client according to another example embodiment.

FIG. 4D illustrates a simplified graphical user interface view provided by a client according to another example embodiment.

FIG. 4E illustrates a simplified graphical user interface view provided by a client according to another example embodiment.

FIG. 4F illustrates a simplified graphical user interface view provided by a client according to another example embodiment.

FIG. 4G illustrates a simplified graphical user interface view provided by a client according to another example embodiment.

### DETAILED DESCRIPTION

The following description illustrates an elevator communication system that comprises an elevator communication network configured to carry elevator system associated data, a plurality of elevator system nodes communicatively connected to the elevator communication network. One or more of the plurality of elevator system nodes may each comprise, for example, a camera associated with an elevator and/or a landing floor served by the elevator and configured to provide image data about the elevator and/or the landing floor, and a sensor associated with the elevator and the landings floors served by the elevators and configured to provide sensor and/or status data for at least one parameter associated with the elevator and/or the landing floor. The elevator communication network further comprises a controller communicatively connected to the elevator communication network. An application server communicatively connected to the elevator communication network is configured to receive first information associated with the elevator communication network, and provide an application interface towards at least one client, the application interface enabling provision of at least part of the first information associated with the elevator communication network to the at least one client. The illustrated solution enables a solution in which accurate and real-time information from the elevator communication network may be provided to one or more clients.

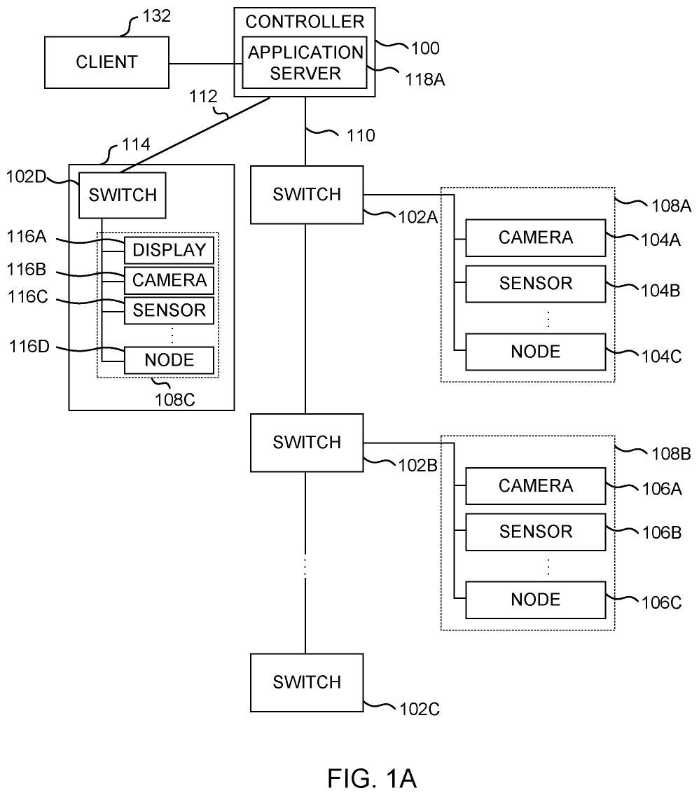

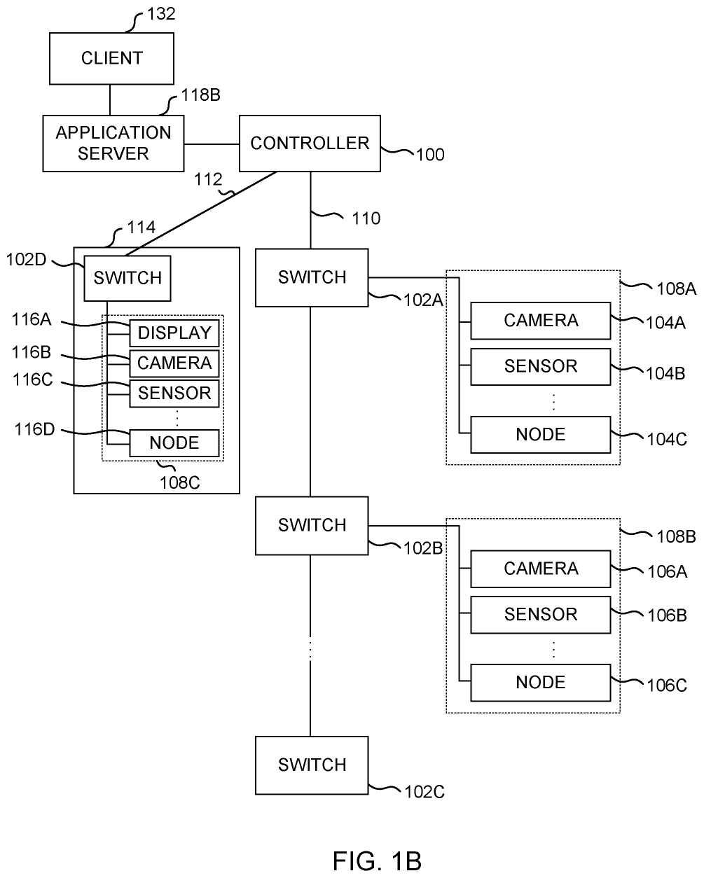

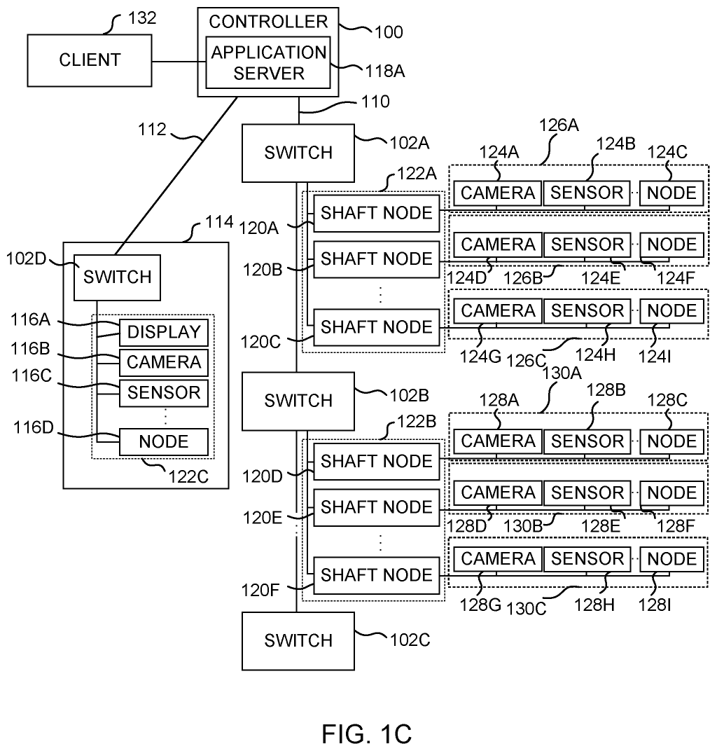

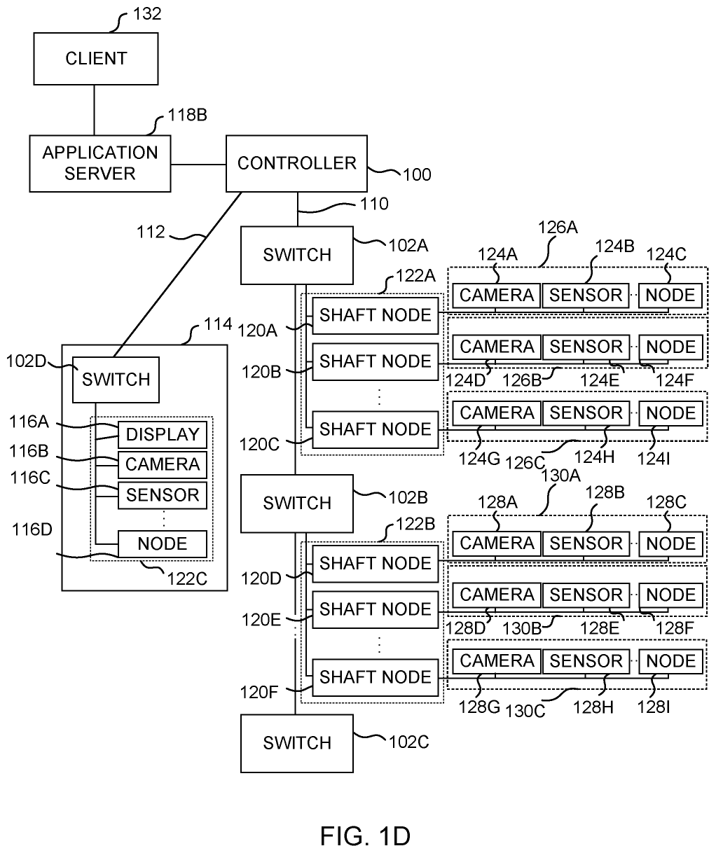

FIG. 1A illustrates an elevator communication system according to an example embodiment. The elevator communication system may comprise a controller 100. The elevator communication system further comprises an elevator communication network configured to carry elevator system associated data. The elevator communication network may be an ethernet-based communication network and it may comprise at least one point-to-point ethernet bus 110, 112 and/or at least one multi-drop ethernet segment 108A, 108B, 108C. The point-to-point ethernet 110, 112 bus may be, for example, a 100BASE-TX or 10BASET1L point-to-point ethernet bus. The multi-drop ethernet bus segments 108A, 108B, 108C may comprise, for example, a 10BASE-T1S multi-drop ethernet bus. The controller 100 may be, for example, an elevator controller or other controlling entity being communicatively connected to the elevator communication network.

In an example embodiment, the elevator communication system may comprise at least one connecting unit 102A, 102B, 102C comprising a first port connected to the respective multi-drop ethernet bus segments 108A, 108B and a second port connected to the point-to-point ethernet bus 110. Thus, by using the connecting units 102A, 102B, 102C, one or more multi-drop ethernet bus segments 108A, 108B may be connected to the point-to-point ethernet bus 110. The connecting unit 102A, 102B, 102C may refer, for example, to a switch.

The elevator communication system may comprise a point-to-point ethernet bus 112 that provides a connection to an elevator car 114 and to various elements associated with the elevator car 114. The elevator car 114 may comprise a connecting unit 102D, for example, a switch, to which one or more elevator car nodes 116A-116D may be connected. In an example embodiment, the elevator car nodes 116A-116D may be connected to the connecting unit 102D via a multi-drop ethernet bus segment 108C, thus constituting an elevator car segment 108C. In an example embodiment, the point-to-point-ethernet bus 112 may be located in the travelling cable of the elevator car 114.

The elevator communication system may further comprise one or more multi-drop ethernet bus segments 108A, 108B (for example, in the form of 10BASE-T1S) reachable by the controller 100, and a plurality of elevator system nodes 104A-104C, 106A-106C coupled to the multi-drop ethernet bus segments 108A, 108B and configured to communicate via the multi-drop ethernet bus segments 108A, 108B. The controller 100 is reachable by the elevator system nodes 104A-104C, 106A-106C via the multi-drop ethernet bus segments 108A, 108B. Elevator system nodes that are coupled to the same multi-drop ethernet bus segment may be configured so that one elevator system node is to be active at a time while the other elevator system nodes of the same multi-drop ethernet bus segment are in a high-impedance state.

In an example embodiment, an elevator system node 104A-104C, 106A-106C may be configured to interface with at least one of an elevator fixture, at least one sensor, an elevator safety device, audio means (for example, a microphone and/or a loudspeaker), a camera and an elevator control device. Further, in an example embodiment, power to the nodes may be provided with the same cabling. In another example embodiment, the elevator system nodes 104A-104C, 106A-106C may comprise shaft nodes, and a plurality of shaft nodes may form a shaft segment, for example, the multi-drop ethernet bus segment 108A, 108B.

At least some of the plurality of elevator system nodes 104A-104C, 106A-106C, 116A-116D each may comprise a camera 104A, 106A associated with different landing floors, respectively, configured to provide image data about a respective landing floor area and a camera 116B configured to provide image data from the elevator car 114. The image data may comprise still image data or video data. The camera 104A, 106A may be integrated into a respective landing floor display which is located, for example, above the landing doors. The camera 104A, 106A may also be integrated into an elevator call device arranged at the landing floor. One or more of the plurality of elevator system nodes 104A-104C, 106A-106C, 116A-116D may comprise a display 116A arranged in the elevator car 114 and/or a display connected directly to the switch 102C. For example, during a normal elevator use, the display 116A may be used as an infotainment device for passengers. On the other hand, for example, in a fire emergency situation, the display 116A may be configured to display data provided by at least one of the cameras 104A, 106A or data received from an external entity outside the elevator communication network. The elevator car 114 may also comprise at least one speaker and microphone. One or more of the plurality of elevator system nodes 104A-104C, 106A-106C, 116A-116D, each may comprise a 104B, 106B, 116C arranged in the elevator car and/or at a landing floor and configured to provide sensor data for at least one parameter associated with the elevators and the landing floors. The sensor may comprise, for example, a temperature sensor, a carbon dioxide sensor, a carbon monoxide sensor, an air moisture sensor, a vibration sensor or any other sensor providing data about locations associated with the elevator system.

In the solution disclosed in FIG. 1A, the controller 100 comprises an application server 118A configured to receive first information associated with the elevator communication network and to provide an application interface towards at least one client 132, the application interface enabling provision of at least part of the first information associated with the elevator communication network to the at least one client 132. In other words, the application server 118A may offer a communication interface to transmit information obtained from the elevator communication network to a client 132. In an example embodiment, the application server 118A may also receive information from the client 132 and communicate the received information further to the elevator communication network. This may enable, for example, a real-time two-way connection between the client 132 and the elevator communication system. The controller 100 may be, for example, an elevator controller or an elevator group controller.

FIG. 1B illustrates an elevator communication system according to another example embodiment. The embodiment illustrated in FIG. 1B is identical with the embodiment illustrated in FIG. 1A with the exception that the application server 118B is a separate entity from the controller 100. The application server 118B may a local server within the elevator communication network or a server outside the elevator communication network, for example, a cloud-based server.

FIG. 1C illustrates an elevator communication system according to another example embodiment. The elevator communication system may comprise a controller 100. The elevator communication system further comprises an elevator communication network configured to carry elevator system associated data. The elevator communication network may be an ethernet-based communication network and it may comprise at least one point-to-point ethernet bus 110, 112 and/or at least one multi-drop ethernet segment 108A, 108B, 108C. The point-to-point ethernet bus may be, for example, a 100BASE-TX or 10BASET1L point-to-point ethernet bus. The multi-drop ethernet bus segments may comprise, for example, a 10BASE-T1S multi-drop ethernet bus. The controller 100 may be, for example, an elevator controller or other controlling entity being communicatively connected to the elevator communication network.

The elevator communication system may comprise a point-to-point ethernet bus 112 that provides a connection to an elevator car 114 and to various elements associated with the elevator car 114. The elevator car 114 may comprise a connecting unit 102D, for example, a switch, to which one or more elevator car nodes 116A-116D may be connected. In an example embodiment, the elevator car nodes 116A-116D may be connected to the connecting unit 102D via a multi-drop ethernet bus segment 122C, thus constituting an elevator car segment 122C. In an example embodiment, the point-to-point-ethernet bus 112 may be located in the travelling cable of the elevator car 114.

The elevator communication system may further comprise one or more multi-drop ethernet bus segments 122A, 122B, 126A-126C, 130A-130C (for example, in the form of 10BASE-T1S) reachable by the controller 100, and a plurality of elevator system nodes 120A-120F, 124A-124I, 128A-128I coupled to the multi-drop ethernet bus segments 122A, 122B, 126A-126C, 130A-130C and configured to communicate via the multi-drop ethernet bus segments 122A, 122B, 126A-126C, 130A-130C. The controller 100 may be reachable by the elevator system nodes 120A-120F, 124A-124I, 128A-128I via the multi-drop ethernet bus segments 122A, 122B, 126A-126C, 130A-130C. Elevator system nodes that are coupled to the same multi-drop ethernet bus segment may be configured so that one elevator system node is to be active at a time while the other elevator system nodes of the same multi-drop ethernet bus segment are in a high-impedance state.

In an example embodiment, the elevator communication system may comprise at least one connecting unit 102A, 102B, 102C comprising a first port connected to the respective multi-drop ethernet bus segments 122A, 122B and a second port connected to the point-to-point ethernet bus 110. Thus, by using the connecting units 102A, 102B, 102C, one or more multi-drop ethernet bus segments 122A, 122B may be connected to the point-to-point ethernet bus 110. The connecting unit 102A, 102B, 102C may refer, for example, to a switch.

In an example embodiment, an elevator system node 116A-116C, 124A-124IC, 128A-128I may be configured to interface with at least one of an elevator fixture, a sensor, an elevator safety device, audio means (for example, a microphone and/or a loudspeaker), a camera and an elevator control device. Further, in an example embodiment, power to the nodes may be provided with the same cabling. In another example embodiment, the elevator system nodes 120A-120F may comprise shaft nodes, and a plurality of shaft nodes may form a shaft segment, for example, the multi-drop ethernet bus segment 122A, 122B.

At least some of the plurality of elevator system nodes 116A-116C, 124A-124I, 128A-128I each may comprise a camera 124A, 124D, 124G, 128A, 128D, 128G arranged at each landing floor configured to provide image data about a respective landing floor area. The camera 124A, 124D, 124G, 128A, 128D, 128G may be integrated into a respective landing floor display which is located, for example, above the landing doors. The camera 124A, 124D, 124G, 128A, 128D, 128G may also be integrated into an elevator call device arranged at the landing floor. One or more of the plurality of elevator system nodes 116A-116C, 124A-124I, 128A-128I may comprise a display 116A arranged in the elevator car 114. For example, during a normal elevator use, the display 116A may be used as an infotainment device for passengers. In an evacuation situation, the display 116A may be configured to display data provided by at least one of the cameras 124A, 124D, 124G, 128A, 128D, 128G. The elevator car 114 may also comprise at least one speaker and microphone. One or more of the plurality of elevator system nodes 116A-116C, 124A-124I, 128A-128I may comprise a sensor 116C, 124B, 124E, 124H, 128A, 128E, 128H arranged in the elevator car 114 and/or at a landing floor and configured to provide sensor data for at least one parameter associated with the elevator and/or the landing floor. The sensor may comprise, for example, a temperature sensor, a carbon dioxide sensor, a carbon monoxide sensor, an air moisture sensor, or a vibration sensor or any other sensor providing data about locations associated with the elevator system.

By implementing communication within the elevator communication system using at least one point-to-point ethernet bus and at least one multi-drop ethernet bus segment, various segments can be formed within the elevator communication system. For example, the elevator system nodes 124A-124C may form a first landing segment 126A, the elevator system nodes 124D-124F may form a second landing segment 126B, the elevator system nodes 124G-124I may form a third landing segment 126C, the shaft nodes 120A-120C may form a first shaft segment 122A, the shaft nodes 120D-120F may form a second shaft segment 122B, and the elevator car nodes 116A-116C may form an elevator car segment 122C. Each of the segments 122A-122C, 126A-126C may be implemented using separate multi-drop ethernet buses.

As illustrated in FIG. 1C, the shaft nodes 120A-120F may interconnect the shaft segments 122A, 122B to which the shaft nodes 124A-124I, 128A-128I are connected to and the landing segments 126A-126C. In other words, the shaft nodes 120A-120C may comprise or may act as a switch to the landing segments 126A-126C, 130A-130C. This may enable a simple solution for adding new elevator system nodes to the elevator communication system. This may also enable a solution in which a single elevator system node may act as a switch or a repeater to another multi-drop ethernet bus segment to which nearby elevator system elements, for example, a call button or buttons, a display or displays, a destination operating panel or panels, a camera or cameras, a voice intercom device etc. may be connected.

In the solution disclosed in FIG. 1C, the controller 100 comprises an application server 118A configured to receive first information associated with the elevator communication network and to provide an application interface towards at least one client 132, the application interface enabling provision of at least part of the first information associated with the elevator communication network to the at least one client 132. In other words, the application server 118A may offer a communication interface to transmit information obtained from the elevator communication network to a client 132. In an example embodiment, the application server may also receive information from the client 132 and communicate the received information further to the elevator communication network. This may enable, for example, a real-time two-way connection between the client 132 and the elevator communication system. The controller 100 may be, for example, an elevator controller or an elevator group controller.

FIG. 1D illustrates an elevator communication system according to another example embodiment. The embodiment illustrated in FIG. 1D is identical with the embodiment illustrated in FIG. 1B with the exception that the application server 118B is a separate entity from the controller 100. The application server 118B may a local server within the elevator communication network or a server outside the elevator communication network, for example, a cloud-based server.

In an example embodiment, the application server 118A, 118B may be configured to obtain a triggering event from the elevator communication network, and open the application interface towards at least one client 132 in response to the triggering event. The triggering event may refer, for example, to a fire alarm, a burglar alarm or another alarm type. In response to the alarm, the application interface is opened so that a client 132 may start receiving data originating from the elevator communication network. This may be useful, for example, in a case of a fire alarm. Once the fire alarm is obtained, the application interface is opened so that the fire service is able to determine the status with the fire based on the information provided via the application interface.

In another example embodiment, the application server 118A, 118B may be configured to determine, based on the first information, that at least one parameter in the first information exceeds a predetermined threshold, and open the application interface towards the at least one client 132 in response to the determination. In other words, one or more thresholds may be configured in the application server 118A, 118B, and the application server 118A, 118B determines when the threshold is exceeded. This enables a solution in which the application server 118A, 118B may be configured with desired thresholds, for example, different warning and alarm levels.

In another example embodiment, the application server 118A, 118B may be configured to determine, based on the first information, that at least one parameter in the first information exceeds a predetermined threshold, and issue at least one alert via the application interface to the at least one client 132 in response to the determination. This may enable, for example, a solution in which the client 132 may constantly receive data from the application server 118A, 118B. When the predetermined threshold is exceeded, the application server 118A, 118B issues the alert to the client 132.

In another example embodiment, the application server 118A, 118B may be configured to constantly provide the at least part of the first information associated with the elevator communication network to the at least one client 132. This is useful, for example, when an external security company monitors a building constantly, or when a security guard inside a building in which the elevator communication network has been arranged monitors the building. The security company and the security guard may then be able to select one or more elevators or landing floor to show image data provided by the cameras 116B, 104A, 106A, 124A, 124D, 124G, 128A, 128D, 128G.

In an example embodiment, the first information may comprise at least one of image data, voice data, status data and sensor data. The at least one of image data, voice data, status data and sensor data comprises at least one of: image and/or voice data associated with at least one landing floor; image and/or voice data associated with at least one elevator car; image and/or voice data associated with at least one elevator shaft; status data associated with at least one elevator car (for example, elevator car door open/close status); status data associated with an operation mode of an elevator (for example, idle, running or prevented due, for example, to fire); data associated with at least one elevator system failure; data associated with at least one elevator system component failure; data associated with at least one rescue need associated with the elevator system (for example, an entrapment of people in an elevator car); sensor data associated with carbon dioxide; sensor data associated with carbon monoxide; sensor data associated with temperature; and sensor data associated with air moisture. In other words, the first information may comprise any data provided by the elevator system.

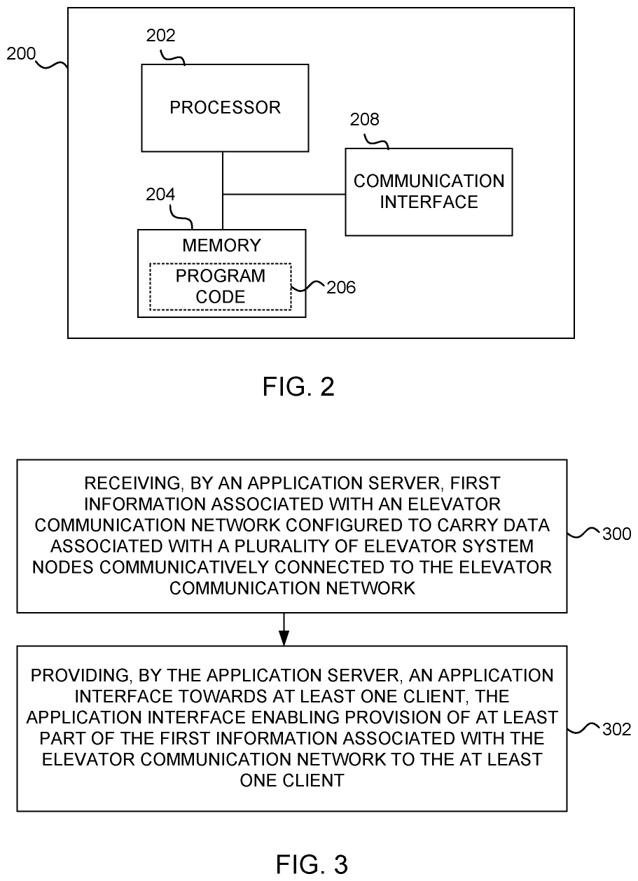

FIG. 2 illustrates an apparatus 200 configured to provide the application server 118A, 118B. The apparatus 200 may comprise at least one processor 202. The apparatus 200 may further comprise at least one memory 204. The memory 204 may comprise program code 206 which, when executed by the processor 202 causes the apparatus 200 to perform at least one example embodiment. The exemplary embodiments and aspects of the subject-matter can be included within any suitable device, for example, including, servers, elevator controllers, workstations, capable of performing the processes of the exemplary embodiments. The exemplary embodiments may also store information relating to various processes described herein. Although the apparatus 200 is illustrated as a single device it is appreciated that, wherever applicable, functions of the apparatus 200 may be distributed to a plurality of devices. The apparatus 200 may be, for example, an elevator controller or other controlling entity being communicatively connected to the elevator communication network.

Example embodiments may be implemented in software, hardware, application logic or a combination of software, hardware and application logic. The example embodiments can store information relating to various methods described herein. This information can be stored in one or more memories 204, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases. Further, the illustrated embodiments and method steps may be implemented as a computer-implemented solution.

The processor 202 may comprise one or more general purpose processors, microprocessors, digital signal processors, micro-controllers, and the like, programmed according to the teachings of the example embodiments, as will be appreciated by those skilled in the computer and/or software art(s). Appropriate software can be readily prepared by programmers of ordinary skill based on the teachings of the example embodiments, as will be appreciated by those skilled in the software art. In addition, the example embodiments may be implemented by the preparation of application-specific integrated circuits or by interconnecting an appropriate network of conventional component circuits, as will be appreciated by those skilled in the electrical art(s). Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like.

As stated above, the components of the example embodiments may include computer readable medium or memories 204 for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

The apparatus 200 may comprise a communication interface 208 configured to enable the apparatus 200 to transmit and/or receive information, to/from other apparatuses, server and/or clients.

The apparatus 200 may comprise means for performing at least one method described herein. In one example, the means may comprise the at least one processor 202, the at least one memory 204 including program code 206 configured to, when executed by the at least one processor 202, cause the apparatus 200 to perform the method.

FIG. 3 illustrates a method according to an example embodiment. The method may be performed, for example, by the application server 118A, 118B illustrated in any of FIGS. 1A-1D.

At 300, first information associated with an elevator communication network configured to carry data associated with a plurality of elevator system nodes 104A-104C, 106A-106C, 116A-116D, 120A-120F, 124A-124I, 128A-128I communicatively connected to the elevator communication network is received.

At 302 an application interface is provided towards at least one client 132, the application interface enabling provision of at least part of the first information associated with the elevator communication network to the at least one client 132.

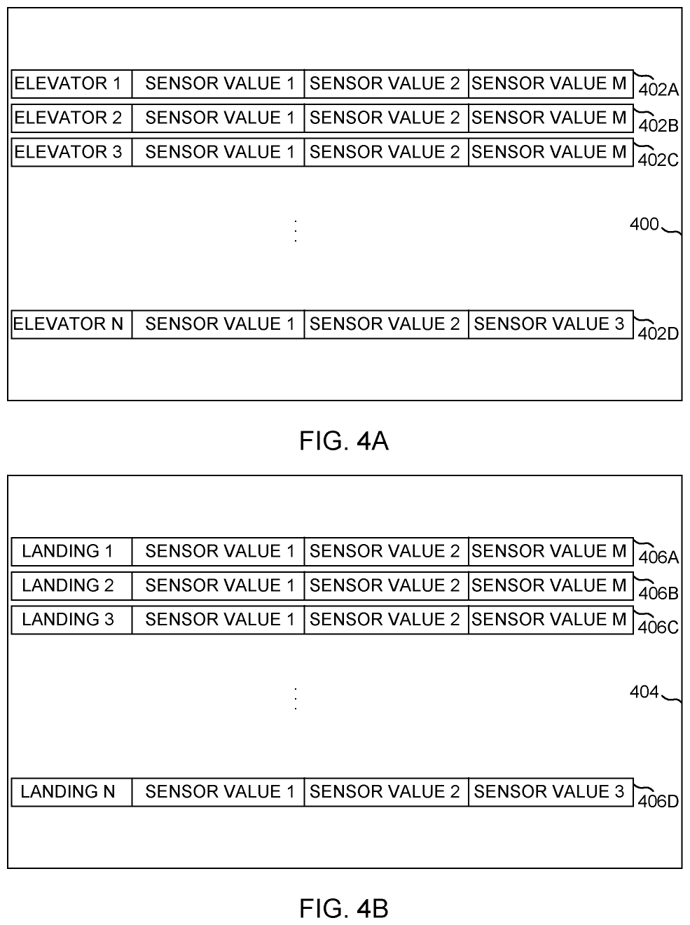

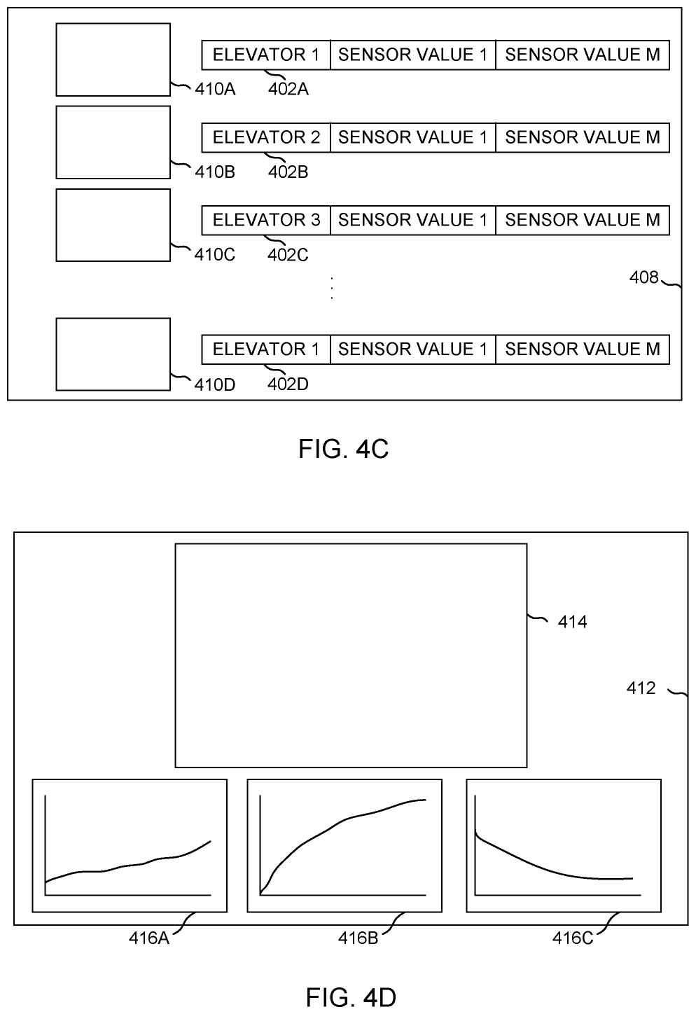

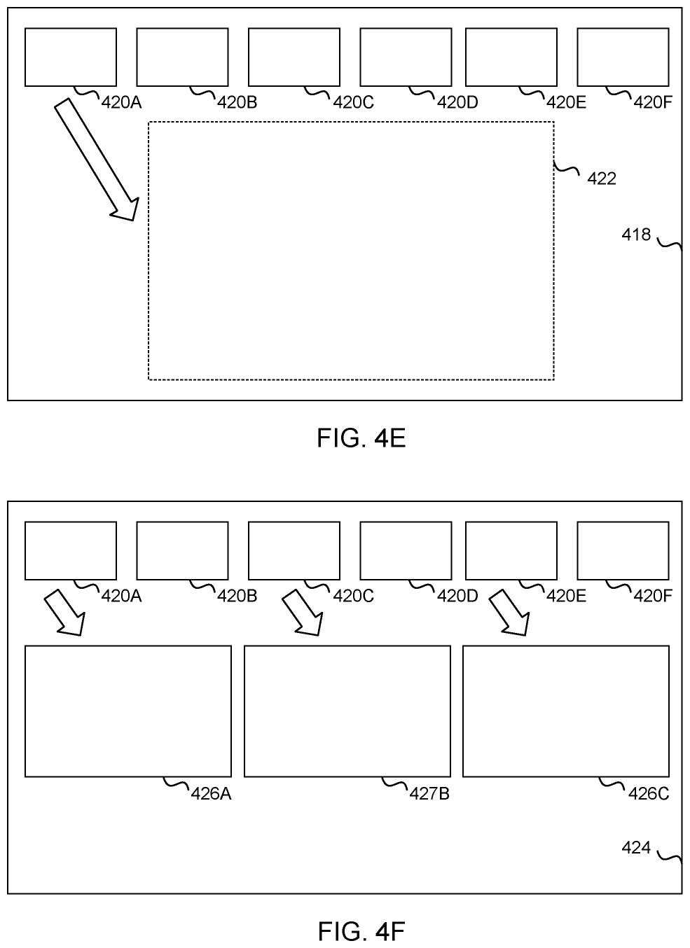

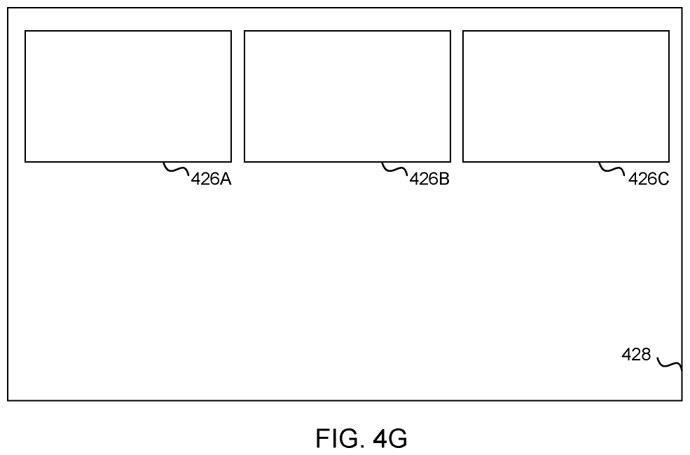

FIG. 4A illustrates a simplified graphical user interface view 400 that may be provided by a client 132 based on information received from the application server 118A, 118B according to an example embodiment. The view 400 may comprise a summary of sensor data 402A, 402B, 402C, 402D associated with a selected set of the plurality of sensors 104B, 106B, 116C, 124B, 124E, 124H, 128B, 128E, 128H. The summary may comprise, for example, current sensor values provided by the sensors 104B, 106B, 116C, 124B, 124E, 124H, 128B, 128E, 128H. The sensors may comprise any sensor that may be used to provide information useful in a fire emergency situation, for example, a temperature sensor, a carbon dioxide sensor, a carbon monoxide sensor, an air moisture sensor or a vibration sensor or any other sensor providing data about locations associated with the elevator system.

FIG. 4B illustrates a simplified graphical user interface view 404 that may be provided by a client 132 based on information received from the application server 118A, 118B according to another example embodiment. The view 404 may comprise a summary of sensor data 406A-406D associated with a selected set of the plurality of sensors 124B, 124E, 124H, 128B, 128E, 128H provided at the landing floors. The summary may comprise, for example, current sensor values provided by the sensors 124B, 124E, 124H, 128B, 128E, 128H. The sensors may comprise any sensor that may be used to provide information useful in a fire emergency situation, for example, a temperature sensor, a carbon dioxide sensor, a carbon monoxide sensor, an air moisture sensor or a vibration sensor or any other sensor providing data about locations associated with the elevator system.

FIG. 4C illustrates a simplified graphical user interface view 408 that may be provided by a client 132 based on information received from the application server 118A, 118B according to another example embodiment. The view 408 may comprise a summary of sensor data 402A, 402B, 402C, 402D associated with a selected set of the plurality of sensors 104B, 106B, 116C, 124B, 124E, 124H, 128B, 128E, 128H and image frames 410A-410D. Each image frame 410A-410D may be associated with a different camera of the plurality of cameras 104A, 106A, 116B, 124A, 124D, 124G, 128A, 128D, 128G. The sensors may comprise any sensor that may be used to provide information useful in a fire emergency situation, for example, a temperature sensor, a carbon dioxide sensor, a carbon monoxide sensor, an air moisture sensor or a vibration sensor or any other sensor providing data about locations associated with the elevator system.

The application server 118A, 118B may be configured to receive information indicating a selection of a miniature image frame and an expanded image frame for the selected miniature frame is provided by the client 132. The term “expanded image frame” may refer to a larger window that shows the image data in a larger form compared to the miniature image frame.

FIG. 4D illustrates a simplified graphical user interface view 412 that may be provided by a client 132 based on information received from the application interface 118A, 118B according to another example embodiment. The view 412 may be provided, for example, a when user selects one of the image frames 410A-410D illustrated in FIG. 4C in order to obtain more information relating to a specific elevator or landing floor. The selection may have been made using a touch-sensitive feature of a display providing the view 412.

The view 412 may comprise an expanded/larger image frame 414 that provides still or live image data from the selected elevator or landing floor. This makes it possible, for example, for the rescue personnel to obtain more accurate information about the elevator or landing floor. The view 412 may also provide more detailed information based on the sensor or sensors arranged in the elevator or landing floor. For example, various graphs 416A-416C may be provided that show how the situation has progressed over the time. For example, the graph 416A may illustrate the temperature in the time domain, the graph 416B may illustrate the carbon dioxide level in the time domain etc. This may give valuable information for the rescue personnel to estimate what the situation is currently and how it has progressed over the time.

FIG. 4E illustrates a simplified graphical user interface view 418 provided by the client 132 according to an example embodiment. The view 418 may comprise a miniature image frame 420A-420F for image data of each camera of the landing floors provided by the application server 118A, 118B. The term “miniature image frame” may refer to a small preview type window showing image data from one camera. In other words, each miniature image frame 420A-420F is configured to display image data from a different landing floor.

The application server 118A, 118B may be configured to receive information indicating a selection of a miniature image frame and provide information for an expanded image frame 422 for the selected miniature frame to the client 132. The term “expanded image frame” may refer to a larger window that shows the image data in a larger form compared to the miniature image frame. A user operating the client 132 may select one of the miniature image frames 420A-420F, for example, using a touch-sensitive display or a pointing device.

The application server 118A, 118B may also be configured to establish a two-way voice communication between audio means of a landing floor associated with the image data of the expanded image frame and the client 132. The audio means may comprise, for example, at least one speaker and microphone. This means that the user operating the client 132 is able to communicate with the passengers waiting at the landing floor or the elevator.

FIG. 4F illustrates a simplified graphical user interface view 424 provided by the client 132 according to another example embodiment. The view 424 may comprise a miniature image frame 420A-420F for image data of each camera of the landing floors. The term “miniature image frame” may refer to a small preview type window showing image data from one camera. In other words, each miniature image frame 420A-4020F may be configured to display image data from a different landing floor.

The application server 118A, 118B may be configured to receiving information indicating a landing call from at least one landing floor from the controller 100, and the view 424 may comprise an expanded image frame 426A, 426B, 426C for image data of a camera of a landing floor from which a landing call exists and a miniature image frame 420B, 420D, 420F for image data of a camera of a landing floor from which no landing call exists. The term “expanded image frame” may refer to a larger window that shows the image data in a larger form compared to the miniature image frame.

The application server 118A, 118B may be configured to receive information indicating a selection of an expanded image frame 406A, 406B, 406C from a user operating the client 132. In response to the selection, the application server 118A, 118B may be configured to establish a two-way voice communication between audio means of a landing floor associated with the image data of the selected expanded image frame and the client 132. The audio means may comprise, for example, at least one speaker and microphone. This means that passengers waiting at the landing floor are able to hear the user of the client 132, and the user of the client 132 is able hear what the passengers speak at the landing floor.

FIG. 4G illustrates a simplified graphical user interface view 428 provided by the client 132 according to another example embodiment.

The application server 118A, 118B may be configured receive information indicating a landing call from at least one landing floor from the controller 100, and the application server 118A, 118B may obtain information associated with the at least one landing floor from the elevator communication network. Based on this information, the client 132 is able to provide an expanded image frame 426A, 426B, 426C for image data of a camera of a landing floor from which a landing call exists. The term “expanded image frame” may refer to a larger window that shows the image data in a larger form compared to the miniature image frame. The application server 118A, 118B may be configured to receive information indicating a selection of an expanded image frame 426A, 426B, 426C from the user of the client 132. In response to the selection, the application server 118A, 118B may be configured to establish a two-way voice communication between audio means of a landing floor associated with the image data of the selected expanded image frame and the client 132. The audio means may comprise, for example, at least one speaker and microphone. This means that passengers waiting at the landing floor are able to hear the user of the client 132, and the user of the client 132 is able to hear what the passengers speak at the landing floor.

In any of the embodiments illustrated in FIGS. 4E-4G, the view 418, 424, 428 provided by the client 132 may comprise a user interface element enabling a simultaneous audio connection to audio means of all landing floors, i.e. enabling a broadcast functionality. The application server 118A, 118B may be configured to receive information indicating a selection of the user interface element and establish a one-way voice communication towards the audio means of each landing floor from the client 132. This enables a situation in which the user of the client 132 may give announcements simultaneously to all landing floors.

At least some of the above discussed example embodiments may enable transmission of any device data seamlessly between elevator system devices and any other device or system. Further, a common protocol stack may be used for all communication. Further, at least some of the above discussed example embodiments may enable a solution in which a user of the client 132 is able to see real-time image and sensor data and hear audio data from an elevator, a landing floor or landing floors, for example, in a fire emergency situation and make decisions based on the obtained data. Further, more generally, a solution may be provided that enables data from the elevator communication system to be provided to a client whether it is a local client or an external client to the elevator communication system. This enables a solution in which various entities, for example, the fire department, a security company, a local security guard etc. is able to obtain real-time information provided by the elevator communication system.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. An application server configured to:
receive first information associated with an elevator communication network configured to carry data associated with a plurality of elevator system nodes communicatively connected to the elevator communication network; and
provide an application interface towards at least one client, the application interface enabling provision of at least part of the first information associated with the elevator communication network to the at least one client.

2. The application server of claim 1, wherein the application server is configured to:
obtain a triggering event from the elevator communication network; and
open the application interface towards the at least one client in response to the triggering event.

3. The application server of claim 2, wherein the triggering event comprises a fire alarm or a burglar alarm.

4. The application server of claim 1, wherein the application server is configured to:
determine, based on the first information, that at least one parameter in the first information exceeds a predetermined threshold; and
open the application interface towards the at least one client in response to the determination.

5. The application server of claim 1, wherein the application server is configured to:
determine, based on the first information, that at least one parameter in the first information exceeds a predetermined threshold; and
issue at least one alert via the application interface to the at least one client in response to the determination.

6. The application server of claim 1, wherein the application server is configured to:
receive via the application interface information indicating a selection of a landing floor; and
wherein the at least part of the first information associated with the elevator communication network comprises information associated with the selected landing floor.

7. The application server of claim 1, wherein the application server is configured to:
receive via the application interface information indicating a selection of an elevator; and
wherein the at least part of the first information associated with the elevator communication network comprises information associated with the selected elevator.

8. The application server of claim 1, wherein the application server is configured to:
receive second information via the application interface from the at least one client; and
transmit the second information to the elevator communication network to enable a two-way connection between the elevator communication network and the at least one client.

9. The application server of claim 8, wherein the second information comprises at least one of image data and voice data.

10. The application server of claim 1, wherein the first information comprises at least one of image data, voice data, status data and sensor data.

11. The application server of claim 10, wherein the at least one of image data, voice data, status data and sensor data comprises at least one of:
image and/or voice data associated with at least one landing floor,
image and/or voice data associated with at least one elevator car;
image and/or voice data associated with at least one elevator shaft;
status data associated with at least one elevator car;
status data associated with an operation mode of an elevator;
data associated with at least one elevator system failure;
data associated with at least one elevator system component failure;
data associated with at least one rescue need associated with the elevator system;
sensor data associated with carbon dioxide;
sensor data associated with carbon monoxide;
sensor data associated with temperature; and
sensor data associated with air moisture.

12. The application server of claim 1, wherein the elevator communication network comprises at least one point-to-point ethernet network.

13. The application server of claim 1, wherein the elevator communication network comprises at least one multi-drop ethernet segment.

14. An elevator system, comprising:
an elevator communication network configured to carry data associated with a plurality of elevator system nodes communicatively connected to the elevator communication network; and
the application of claim 1.

15. A method comprising:
receiving, by an application server, first information associated with an elevator communication network configured to carry data associated with a plurality of elevator system nodes communicatively connected to the elevator communication network; and
providing, by the application server, an application interface towards at least one client, the application interface enabling provision of at least part of the first information associated with the elevator communication network to the at least one client.

16. The method of claim 15, further comprising:
obtaining a triggering event from the elevator communication network; and
opening the application interface towards the at least one client in response to the triggering event.

17. The method of claim 16, wherein the triggering event comprises a fire alarm or a burglar alarm.

18. The method of claim 15, further comprising:
determining, based on the first information, that at least one parameter in the first information exceeds a predetermined threshold; and
opening the application interface towards the at least one client in response to the determination.

19. The method of claim 15, further comprising:
determining, based on the first information, that at least one parameter in the first information exceeds a predetermined threshold; and
issuing at least one alert via the application interface to the at least one client in response to the determination.

20. The method of claim 15, further comprising receiving via the application interface information indicating a selection of a landing floor,
wherein the at least part of the first information associated with the elevator communication network comprises information associated with the selected landing floor.

21. The method of claim 15, further comprising receiving via the application interface information indicating a selection of an elevator,
wherein the at least part of the first information associated with the elevator communication network comprises information associated with the selected elevator.

22. The method of claim 15, further comprising:
receiving second information via the application interface from the at least one client; and
transmitting the second information to the elevator communication network to enable a two-way connection between the elevator communication network and the at least one client.

23. The method of claim 22, wherein the second information comprises at least one of image data and voice data.

24. The method of claim 15, wherein the first information comprises at least one of image data, voice data, status data and sensor data.

25. The method of claim 24, wherein the at least one of image data, voice data, status data and sensor data comprises at least one of:
image and/or voice data associated with at least one landing floor;
image and/or voice data associated with at least one elevator car;
image and/or voice data associated with at least one elevator shaft;
status data associated with at least one elevator car;
status data associated with an operation mode of an elevator;
data associated with at least one elevator system failure;
data associated with at least one elevator system component failure;
data associated with at least one rescue need associated with the elevator system;
sensor data associated with carbon dioxide;
sensor data associated with carbon monoxide;
sensor data associated with temperature; and
sensor data associated with air moisture.

26. The method of claim 15, wherein the elevator communication network comprises at least one point-to-point ethernet network.

27. The method of claim 15, wherein the elevator communication network comprises at least one multi-drop ethernet segment.

28. (canceled)

29. A non-transitory computer readable medium comprising program code, which when executed by at least one processor, causes the at least one processor to perform the method of claim 15.
